(19) United States
(12) Patent Application Publication
(10) Pub. No.: US 2024/0430917 A1
(43) Pub. Date: Dec. 26, 2024

(54) INTER-UE COORDINATION SCHEME RESTRICTION DURING CONGESTION

(71) Applicant: Lenovo (Singapore) Pte. Ltd., New Tech Park (SG)

(72) Inventors: Karthikeyan Ganesan, Kronberg im Taunus (DE); Prateek Basu Mallick, Dreieich (DE); Joachim Löhr, Wiesbaden (DE)

(21) Appl. No.: 18/707,526

(22) PCT Filed: Nov. 3, 2022
(86) PCT No.: PCT/IB2022/060617

§ 371 Date: May 3, 2024

Related U.S. Application Data
(60) Provisional application No. 63/275,352, filed on Nov. 3, 2021.

(51) Int. Cl. H04W 72/40; H04B 17/318; H04W 72/02; H04W 72/25; H04W 72/52

(52) U.S. Cl. CPC H04W 72/40; H04B 17/318; H04W 72/02; H04W 72/25; H04W 72/52

(57) ABSTRACT

Apparatuses, methods, and systems are disclosed for inter-UE coordination (“IUC”) scheme restriction during congestion. An apparatus (700) includes a memory (710) and a processor (705) coupled to the memory (710). The processor (705) is configured to cause the apparatus (700) to identify a configuration comprising a lookup table defining a restriction of one or more inter-CE coordination schemes between the apparatus (700) and a second apparatus (700) and transmit an inter-UE coordination report to the second apparatus (700) according to the identified configuration and based at least in part on a request for the inter-UE coordination report from the second apparatus (700) or a condition.

### CROSS-REFERENCE TO RELATED APPLICATIONS

This application claims priority to U.S. Patent Application Ser. No. 63/275,352 entitled “RESTRICTION ON THE USAGE OF INTER-UE COORDINATION SCHEMES DURING CONGESTION” and filed on Nov. 3, 2021, for Karthikeyan Ganesan, et al., which is incorporated herein by reference in its entirety.

### FIELD

The subject matter disclosed herein relates generally to wireless communications and more particularly relates to restriction on the usage of inter-user equipment (“UE”) coordination schemes during congestion.

### BACKGROUND

In wireless networks, congestion control mechanisms work by measuring the sidelink (“SL”)-received signal strength indicator (“RSSI”) within the congestion window defined by the gNB, if the SL-RSSI is above a certain metric, transmission parameter restrictions such as power reduction, modulation coding scheme (“MCS”) reduction, number of subchannels, or the like may be limited for physical sidelink control channel (“PSCCH”) and/or physical sidelink shared channel (“PSSCH”) transmission.

### BRIEF SUMMARY

Disclosed are solutions for restriction on the usage of inter-UE coordination schemes during congestions. The solutions may be implemented by apparatus, systems, methods, or computer program products.

In one embodiment, a first apparatus includes a memory and a processor coupled to the memory. In one embodiment, the processor is configured to cause the apparatus to identify a configuration comprising a lookup table defining a restriction of one or more inter-UE coordination schemes between the apparatus and a second apparatus and transmit an inter-UE coordination report to the second apparatus according to the identified configuration and based at least in part on a request for the inter-UE coordination report from the second apparatus or a condition.

In one embodiment, a first method identifies a configuration comprising a lookup table defining a restriction of one or more inter-UE coordination schemes between a first apparatus and a second apparatus and transmits an inter-UE coordination report to the second apparatus according to the identified configuration and based at least in part on a request for the inter-UE coordination report from the second apparatus or a condition.

In one embodiment, a second apparatus includes a memory and a processor coupled to the memory. In one embodiment, the processor is configured to cause the apparatus to transmit a request to a second apparatus for an inter-UE coordination report associated with one or more inter-UE coordination schemes between the apparatus and the second apparatus. In one embodiment, in response to the transmitted request, the processor is configured to cause the apparatus to wait a predefined period of time until a packet delay budget, select, in response to waiting the predefined period of time, one or more resources based on a sensing result for transmission of a transport block towards the second apparatus, and receive, using the selected resources, a report from the second apparatus comprising a reason that the inter-UE coordination report was not transmitted.

In one embodiment, a second method transmits a request to a second apparatus for an inter-UE coordination report associated with one or more inter-UE coordination schemes between the apparatus and the second apparatus. In one embodiment, in response to the transmitted request, the second method waits a predefined period of time until a packet delay budget, selects, in response to waiting the predefined period of time, one or more resources based on a sensing result for transmission of a transport block towards the second apparatus, and receives, using the selected resources, a report from the second apparatus comprising a reason that the inter-UE coordination report was not transmitted.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for restriction on the usage of inter-UE coordination schemes during congestions;

FIG. 2 depicts an SL-CBR-PriorityTxConfigList information element:

FIG. 3 depicts an SL-CBR-CommonTxConfigList information element:

FIG. 4 depicts an example process flow for inter-UE coordination (“IUC”) schemes:

FIG. 5 depicts a processing timeline and periodic IUC report transmission:

FIG. 6 is a diagram illustrating one embodiment of a new radio (“NR”) protocol stack:

FIG. 7 is a block diagram illustrating one embodiment of a UE apparatus that may be used for restriction on the usage of IUC schemes during congestions:

FIG. 8 is a block diagram illustrating one embodiment of a network apparatus that may be used for restriction on the usage of IUC schemes during congestions:

FIG. 9 is a flowchart diagram illustrating one embodiment of a method for restriction on the usage of IUC schemes during congestions; and

FIG. 10 is a flowchart diagram illustrating one embodiment of a method for restriction on the usage of IUC schemes during congestions.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising.” “having,” and variations thereof mean “including but not limited to,” unless expressly specified otherwise. An enumerated listing of items does not imply that any or all of the items are mutually exclusive, unless expressly specified otherwise. The terms “a.” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for restriction on the usage of IUC schemes during congestions. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In one embodiment, there are different IUC schemes, which may include:
Scheme 1a—preferred resource set;
Scheme 1b—non-preferred resource set; and
Scheme 2—expected/potential resource conflict indication on the reserved resources.

In Scheme 1a and Scheme 1b, a first UE, UE-A, sends a set of resources to a second UE, UE-B, based on explicit triggering information received from UE-B or autonomously triggered based on fulfilling certain conditions. Medium access control (“MAC”) control element (“CE”), PSSCH, sidelink control information (“SCI”), or the like are candidates for transmitting the set of resources based on explicit request or condition-based triggering. Scheme 2 may use physical sidelink feedback control channel (“PSFCH”) to signal the conflict on the reserved resources. In one embodiment, transmitting the set of resources by UE-A for scheme 1 incurs a large signaling overhead based on the sensing result of UE-A.

In one embodiment, congestion control mechanisms work by measuring the SL-RSSI within the congestion window defined by gNB. If the SL-RSSI is above a certain metric, transmission (“Tx”) parameter restrictions such as power reduction, MCS reduction, number of subchannels, or the like, may be limited for PSCCH and PSSCH transmission.

In this disclosure, IUC schemes could be restricted based on the congestion control mechanism. During congestion control, schemes may need to be restricted to provide resources for PSCCH/PSSCH transmissions and not all schemes may be beneficial when the resource pool is congested as the number of available resources is limited for transmitting PSCCH, PSSCH, and IUC messages.

In one embodiment, restriction of IUC schemes based on channel busy ratio (“CBR”) includes:
A lookup table that is (pre) configured and links the CBR range and per packet priority value with that of limiting/restricting each of the IUC schemes;
Based on the CBR and/or per packet priority of the transmission of explicit request from UE-B to UE-A or to one or more destination id(s) or cast type(s) may be restricted;
Based on the CBR and/or per packet priority of the transmission of report for one or more schemes based on condition based feedback from UE-A to UE-B may be restricted based on cast type, one or more destinations, or the like.
The restriction on the IUC schemes may be (pre) configured as part of the sl-CBR-PSSCH-TxConfigList such that when CBR and per packet priority limits/restricts the transmission of PSSCH/PSCCH, then the corresponding limitation/restriction may also apply for one or more IUC schemes based on explicit request and/or condition-based triggering.
The number of resources reported as part of the IUC message could be a limiting factor, considering that reporting more number/percentage of resources incurs more signaling overhead. For each CBR value/range and/or packet priority restrict the number/percentage of reported resource corresponding to scheme 1a and/or scheme 1b which could be (pre) configured per resource pool.

Another embodiment is directed to determining the UE-A behavior when it receives an explicit request for IUC when the CBR restricts the transmission of one or more IUC schemes:
UE-A may drop/ignore/skip the explicit request due to the limitation or restriction of one or more schemes due to higher CBR e.g., congested scenario, or based on a measured RSSI exceeding a (pre) configured threshold at UE-A, where a separate threshold may be (pre) configured compared to the CBR and in such cases IUC pending flag in MAC is not set accordingly;
UE-A may report back to UE-B why the transmission of set of resource may be dropped, a field in MAC CE or SCI could be defined with a set of values and each set providing a specific reason for dropping the IUC report;
when UE-B does not receive the corresponding IUC report for which the request was transmitted, UE-B waits until a (pre)-defined time until the PDB and selects resources based on its sensing result for the transmission of TB towards UE-A. If the IUC report arrives after the transmission of TB, UE-B may (re) select if UE-B does make some reservation or (pre) selected any resources for future new TB transmission or (re) transmission of the previous TB.

In one embodiment, directed to MAC CE format for transmitting IUC report, when an IUC trigger contains transmission of one or more report based on scheme 1a and/or scheme 1b, then a new MAC CE that is variable in size could be defined. In one embodiment, directed to IUC report transmission using SCI, a new second SCI format is defined for the transmission of one or more IUC report corresponding to scheme 1a and/or scheme 1b.

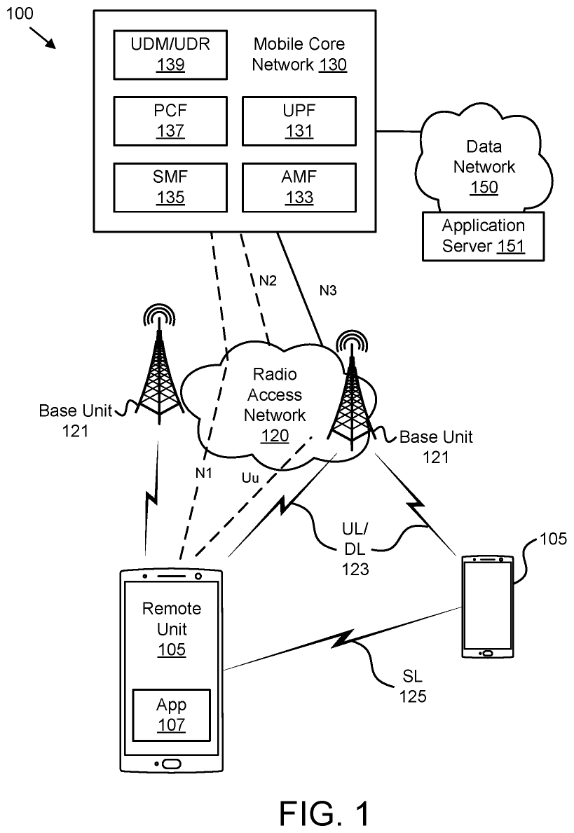

FIG. 1 depicts a wireless communication system 100 supporting restriction on the usage of IUC schemes during congestion, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, two or more remote units 105 may be in direct communication with one another via a sidelink communication link 125. As used herein, sidelink is a networking topology that enables direct communication between two devices without the participation of a base station in the transmission and reception of data traffic.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”), a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting CSI enhancements for higher frequencies.

As background, regarding sidelink congestion control in sidelink resource allocation mode 2, if a UE is configured with higher layer parameter sl-CR-Limit and transmits PSSCH in slot n, the UE shall ensure the following limits for any priority value k:

$$\\ {\sum }_{i \geq k} CR ( i ) \leq {CR}_{Limit} ( k )$$

where CR(i) is the CR evaluated in slot n-N for the PSSCH transmissions with ‘Priority’ field in the SCI set to i, and CR_{Limit}(k) corresponds to the high layer parameter sl-CR-Limit that is associated with the priority value k and the CBR range which includes the CBR measured in slot n-N, where N is the congestion control processing time.

The congestion control processing time N is based on u of Table 1 and Table 2 for UE processing capability 1 and 2 respectively, where u corresponds to the subcarrier spacing of the sidelink channel with which the PSSCH is to be transmitted. A UE shall only apply a single processing time capability in sidelink congestion control.

| μ | Congestion control processing time N [slots] |
|---|---|
| 0 | 2 |
| 1 | 2 |
| 2 | 4 |
| 3 | 8 |

| μ | Congestion control processing time N [slots] |
|---|---|
| 0 | 2 |
| 1 | 4 |
| 2 | 8 |
| 3 | 16 |

It is up to UE implementation how to meet the above limits, including dropping the transmissions in slot n.

In one embodiment, congestion control can restrict the values of at least the following PSSCH/PSCCH TX parameters per resource pool:
Range of MCS for a given MCS table supported within the resource pool
Range of number of sub-channels
Upper bound of number of (re) transmissions-already agreed in mode 2 AI
Upper bound of TX power (including zero TX power)

In one embodiment, congestion control can set an upper bound on channel occupancy ratio (“CR”), CRₗᵢₘᵢₜ. Ranges/bounds of the transmission parameters and CRₗᵢₘᵢₜ are functions of QoS and CBR. In addition to congestion control (in use or not in use), the above parameters can be restricted by reusing the same mechanism as in LTE.

In one embodiment, in addition to congestion control (in use or not in use), the following PSSCH/PSCCH TX parameters per resource pool can be restricted by reusing the same mechanism as in LTE:
Range of MCS for a given MCS table supported within the resource pool
Range of number of sub-channels
Upper bound of number of (re) transmissions

Regarding 3GPP TS 38.331-Sidelink congestion control:

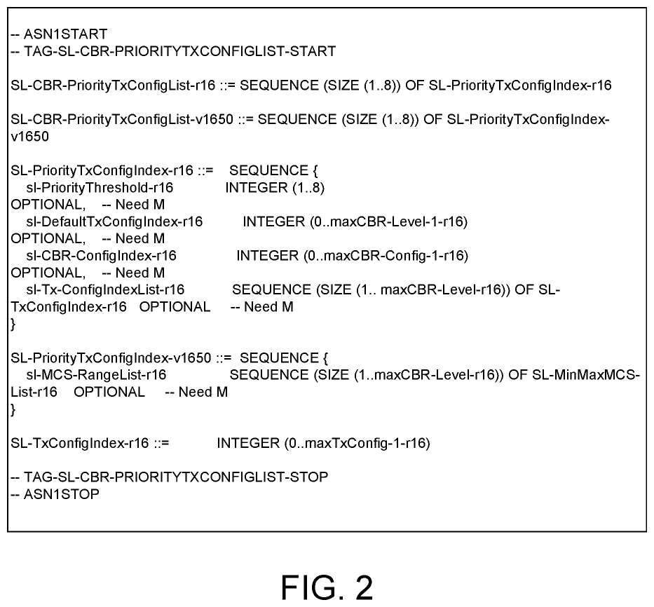

The IE SL-CBR-PriorityTxConfigList, shown in FIG. 2, indicates the mapping between PSSCH transmission parameter (such as MCS, PRB number, retransmission number, CR limit) sets by using the indexes of the configurations provided in sl-CBR-PSSCH-TxConfigList, CBR ranges by an index to the entry of the CBR range configuration in sl-CBR-RangeConfigList, and priority ranges. It also indicates the default PSSCH transmission parameters to be used when CBR measurement results are not available, and MCS range for the MCS tables used in the resource pool.

SL-CBR-PriorityTxConfigList field descriptions

sl-CBR-ConfigIndex
Indicates the CBR ranges to be used by an index to the entry of the
CBR range configuration in sl-CBR-RangeConfigList.
sl-DefaultTxConfigIndex
Indicates the PSSCH transmission parameters to be used by the UEs
which do not have available CBR measurement results, by means of an
index to the corresponding entry in tx-ConfigIndexList. Value 0
indicates the first entry in tx-ConfigIndexList. The field is ignored if
the UE has available CBR measurement results.
sl-MCS-RangeList
Indicates the minimum MCS value and maximum MCS value for the
associated MCS table(s). UE shall ignore the minimum MCS value and
maximum MCS value used for table of 64QAM indicated in SL-CBR-
PriorityTxConfigList-r16 if SL-CBR-PriorityTxConfigList-v1650 is
present.
sl-PriorityThreshold
Indicates the upper bound of priority range which is associated with the
configurations in sl-CBR-ConfigIndex and in sl-Tx-ConfigIndexList.
The upper bounds of the priority ranges are configured in ascending
order for consecutive entries of SL-PriorityTxConfigIndex in SL-CBR-
PriorityTxConfigList. For the first entry of SL-PriorityTxConfigIndex,
the lower bound of the priority range is 1.
SL-CBR-PriorityTxConfigList-v1650
If included, it includes the same number of entries, and listed in the
same order, as in SL-CBR-PriorityTxConfigList-r16.

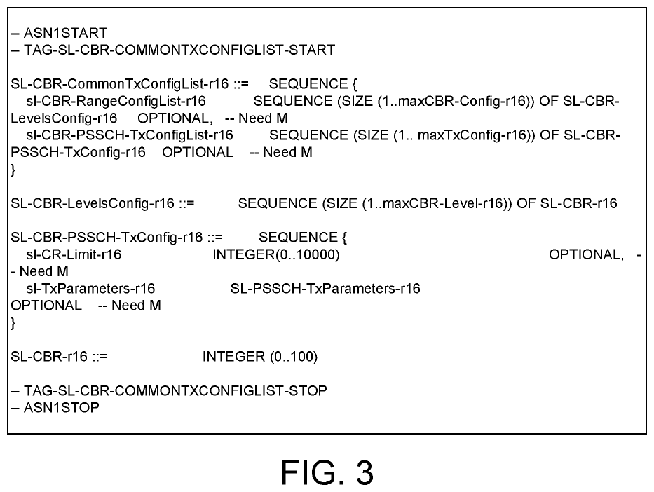

The IE SL-CBR-CommonTxConfigList, shown in FIG. 3, indicates the list of PSSCH transmission parameters (such as MCS, sub-channel number, retransmission number, CR limit) in sl-CBR-PSSCH-TxConfigList, and the list of CBR ranges in sl-CBR-RangeConfigList, to configure congestion control to the UE for sidelink communication.

SL-CBR-CommonTxConfigList field descriptions

sl-CBR-RangeConfigList
Indicates the list of CBR ranges. Each entry of the list indicates in SL-
CBR-LevelsConfig the upper bound of the CBR range for the respective
entry. The upper bounds of the CBR ranges are configured in ascending
order for consecutive entries of sl-CBR-RangeConfigList. For the first
entry of sl-CBR-RangeConfigList the lower bound of the CBR range is
0. Value 0 corresponds to 0, value 1 to 0.01, value 2 to 0.02, and so on.
sl-CR-Limit
Indicates the maximum limit on the occupancy ratio. Value 0
corresponds to 0, value 1 to 0.0001, value 2 to 0.0002, and so on
(i.e., in steps of 0.0001) until value 10000, which corresponds to 1.
sl-CBR-PSSCH-TxConfigList
Indicates the list of available PSSCH transmission parameters (such as
MCS, sub-channel number, retransmission number and CR limit)
configurations.
sl-TxParameters
Indicates PSSCH transmission parameters.

Regarding Sidelink Rel17 agreements on the IUC, in one embodiment, the schemes of IUC in Mode 2 are categorized as being based on the following types of “A set of resources” sent by UE-A to UE-B:
UE-A sends to UE-B the set of resources preferred for UE-B's transmission 1. e.g., based on its sensing result
UE-A sends to UE-B the set of resources not preferred for UE-B's transmission 1. e.g., based on its sensing result and/or expected/potential resource conflict.
UE-A sends to UE-B the set of resource where the resource conflict is detected

In one embodiment, for IUC Scheme 1, the coordination information sent from UE-A to UE-B is the set of resources preferred and/or non-preferred for UE-B's transmission.

In one embodiment, for IUC Scheme 2, the coordination information sent from UE-A to UE-B is the presence of expected/potential and/or detected resource conflict on the resources indicated by UE-B's SCI.

In one embodiment, when UE-B receives the IUC information from UE-A, consider at least one of the following options for UE-Bs to take it into account in the resource (re)-selection for its own transmission:

For scheme 1:
Option 1-1: UE-B's resource(s) to be used for its transmission resource (re)-selection is based on both UE-B's sensing result (if available) and the received coordination information
Option 1-2: UE-B's resource(s) to be used for its transmission resource (re)-selection is based only on the received coordination information
Option 1-3: UE-B's resource(s) to be re-selected based on the received coordination information
Option 1-4: UE-B's resource(s) to be used for its transmission resource (re)-selection is based on the received coordination information

For scheme 2:
Option 2-1: UE-B can determine resource(s) to be re-selected based on the received coordination information
Option 2-2: UE-B can determine a necessity of retransmission based on the received coordination information

In one embodiment, for scheme 1, the following IUC information signaling from UE-A is supported:
Set of resources preferred for UE-B's transmission
Set of resources non-preferred for UE-B's transmission

In one embodiment, for scheme 2, the following IUC information signaling from UE-A is supported:
Presence of expected/potential resource conflict on the resources indicated by UE-B's SCI

In one embodiment, in scheme 1, the following is supported for UE(s) to be UE-A(s)/UE-B(s) in the IUC information transmission triggered by an explicit request in Mode 2:
A UE that sends an explicit request for IUC information can be UE-B
A UE that received an explicit request from UE-B and sends IUC information to the UE-B can be UE-A.

At least a destination UE of a TB transmitted by UE-B can be UE A
The above feature can be enabled or disabled or controlled by (pre-) configuration

In one embodiment, in scheme 1, the following is supported for UE(s) to be UE-A(s)/UE-B(s) in the IUC information transmission triggered by a condition other than explicit request reception in Mode 2:
A UE that satisfies the condition mentioned in the main bullet and sends IUC information is UE-A.
A UE that received IUC information from UE-A and uses it for resource (re-)selection is UE-B
The above feature can be enabled or disabled or controlled by (pre-) configuration

In one embodiment, in scheme 2, at least the following is supported for UE(s) to be UE-A(s)/UE-B(s) in the IUC transmission triggered by a detection of expected/potential resource conflict(s) in Mode 2:
A UE that transmitted PSCCH/PSSCH with SCI indicating reserved resource(s) to be used for its transmission, received IUC information from UE-A indicating expected/potential resource conflict(s) for the reserved resource(s), and uses it to determine resource re-selection is UE-B
A UE that detects expected/potential resource conflict(s) on resource(s) indicated by UE-B's SCI sends IUC information to UE-B, subject to satisfy one of the following conditions, is UE-A.
At least a destination UE of one of the conflicting TBs, i.e., TBs to be transmitted in the expected/potential conflicting resource(s).
Whether a non-destination UE of a TB transmitted by UE-B can be UE-A is (pre-)configured

In one embodiment, in scheme 2, the following UE-B's behavior in its resource (re) selection is supported when it receives IUC information from UE-A:
UE-B can determine resource(s) to be re-selected based on the received coordination information
UE-B can reselect resource(s) reserved for its transmission when expected/potential resource conflict on the resource(s) is indicated

In one embodiment, in scheme 1, at least following UE-B's behavior in its resource (re-)selection is supported when it receives IUC information from UE-A:

For preferred resource set, the following two options are supported:
Option A): UE-B's resource(s) to be used for its transmission resource (re-)selection is based on both UE-B's sensing result (if available) and the received coordination information
UE-B uses in its resource (re-)selection, resource(s) belonging to the preferred resource set in combination with its own sensing result
UE-B uses in its resource (re-)selection, resource(s) not belonging to the preferred resource set when condition(s) are met
This option is supported when UE-B performs sensing/resource exclusion
Option B): UE-B's resource(s) to be used for its transmission resource (re-)selection is based only on the received coordination information
UE-B uses in its resource (re-)selection, resource(s) belonging to the preferred resource set
This option is supported at least when UE-B does not support sensing/resource exclusion

For non-preferred resource set, UE-B's resource(s) to be used for its transmission resource (re-)selection is based on both UE-B's sensing result (if available) and the received coordination information. UE-B excludes in its resource (re-)selection, resource(s) overlapping with the non-preferred resource set.

In one embodiment, in scheme 2, at least the following is supported to determine IUC information:
Among resource(s) indicated by UE-B's SCI, UE-A considers that expected/potential resource conflict occurs on the resource(s) satisfying at least one of the following condition(s):
Condition 2-A-1: Other UE's reserved resource(s) identified by UE-A are fully/partially overlapping with resource(s) indicated by UE-B's SCI in time-and-frequency
Condition 2-A-2: Resource(s) (e.g., slot(s)) where UE-A, when it is intended receiver of UE-B, does not expect to perform SL reception from UE-B due to half duplex operation

In one embodiment, in scheme 1, at least the following is supported to determine IUC information of preferred resource set: UE-A considers any resource(s) satisfying all the following condition(s) as set of resource(s) preferred for UE-B's transmission.

Condition 1-A-1: Resource(s) excluding those overlapping with reserved resource(s) of other UE identified by UE-A whose reference signal received power (“RSRP”) measurement is larger than a RSRP threshold.

Resource(s) excluding slot(s) where UE-A, when it is intended receiver of UE-B, does not expect to perform SL reception from UE-B. Resource(s) satisfying UE-B's traffic requirement (if available).

In one embodiment, in scheme 1, at least the following is supported to determine IUC information of non-preferred resource set: UE-A considers any resource(s) satisfying at least one of the following condition(s) as set of resource(s) non-preferred for UE-B's transmission.

Condition 1-B-1: Reserved resource(s) of other UE identified by UE-A from other UEs' SCI (including priority field) and RSRP measurement.

Resource(s) (e.g., slot(s)) where UE-A, when it is intended receiver of UE-B, does not expect to perform SL reception from UE-B

In one embodiment, for Scheme 2, PSFCH format 0 is used to convey the presence of expected/potential resource conflict on reserved resource(s) indicated by UE-B's SCI.

In one embodiment, for Condition 2-A-1 of Scheme 2, down-select one or more of the following additional criteria to determine resource(s) where expected/potential resource conflict occurs:
Option 1: The resource(s) are fully/partially overlapping in time-and-frequency with other UE's reserved resource(s) whose RSRP measurement is larger than an RSRP threshold according to the priorities included in the SCI.
Option 2: The resource(s) are fully/partially overlapping in time-and-frequency with other UE's reserved resource(s) whose RSRP measurement is within a (pre) configured RSRP threshold compared to the RSRP measurement of UE-B's reserved resource.
Option 3: The resource(s) are fully/partially overlapping in time-and-frequency with other UE's reserved resource(s) and the other UE is within a distance threshold of UE-B as determined by both UEs' SCIs.
Option 4: The resource(s) are fully/partially overlapping in time-and-frequency with other UE's reserved resource(s) whose RSRP measurement is larger a (pre) configured RSRP threshold compared to the RSRP measurement of UE-B's reserved resource.

In one embodiment, for Condition 1-B-1 of Scheme 1, the following two options are supported:
Option 1: Reserved resource(s) of other UE(s) identified by UE-A whose RSRP measurement is larger than a (pre) configured RSRP threshold which is determined by at least priority value indicated by SCI of the UE(s).
Option 2: Reserved resource(s) of other UE identified by UE-A whose RSRP measurement is smaller than a (pre) configured RSRP threshold which is determined by at least priority value indicated by SCI of the UE(s) when UE-A is a destination of a TB transmitted by the UE(s).

In one embodiment, for Scheme 1 with non-preferred resource set, support following condition: Condition 1-B-2: Resource(s) (e.g., slot(s)) where UE-A, when it is intended receiver of UE-B, does not expect to perform SL reception from UE-B due to half duplex operation.

In one embodiment, for Condition 1-A-1 of Scheme 1, the set of resources preferred for UE-B's transmission is a form of candidate single-slot resource as specified in Rel-16 TS 38.214 Section 8.1.4 (incorporated herein by reference).

When the IUC information transmission is triggered by UE-B's explicit request, the candidate single-slot resource(s) are determined in the same way according to Rel-16 TS 38.214 Section 8.1.4 with at least following parameters provided by signaling from UE-B:
Priority value to be used for PSCCH/PSSCH transmission, replaces prio_TX
Number of sub-channels to be used for PSSCH/PSCCH transmission in a slot, replaces L_subCH.

Resource reservation interval, replaces P_rsvp_TX

For Scheme 1 with preferred resource set, support following condition:

Condition 1-A-2: Resource(s) excluding slot(s) where UE-A, when it is intended receiver of UE-B, does not expect to perform SL reception from UE-B due to half duplex operation. This can be disabled by RRC (pre-) configuration

For allocating PSFCH resources in Scheme 2, at least following can be (pre) configured separately from those for SL HARQ-ACK feedback: set of PRBs for PSFCH transmission/reception (sl-PSFCH-RB-Set).

For Scheme 2, an index of a PSFCH resource for IUC information transmission is determined in the same way according to Rel-16 TS 38.213 Section 16.3 with at least following modification:
P_ID is L1-Source ID indicated by UE-B's SCI
M_ID is 0

For the proposed solution, in the following the term eNB/gNB is used for the base station but it is replaceable by any other radio access node, e.g., BS, eNB, gNB, AP, NR etc. Further the proposed methods are described mainly in the context of 5G NR. However, the proposed solutions/methods are also equally applicable to other mobile communication systems supporting serving cells/carriers being configured for Sidelink Communication over PC5 interface.

Channel busy ratio (“CBR”) provides an overall view on channel congestion by measuring the subchannels over the window size of last 100 ms or 100 slots whichever is (pre) configured and a sidelink resource is busy for the purpose of CBR measurement if Sidelink RSSI measured by the UE in that resource exceeds a (pre-)configured threshold.

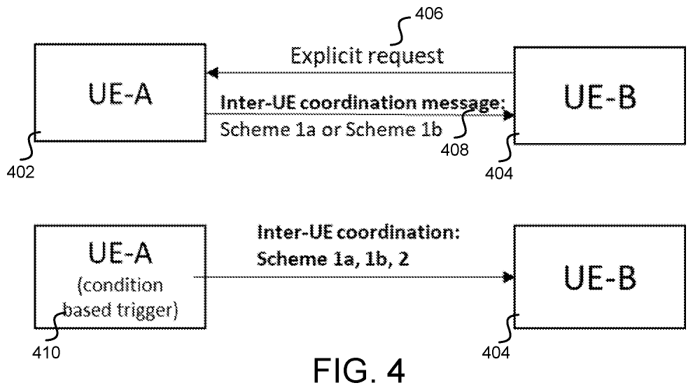

A first embodiment is directed to restriction of IUC schemes based on CBR. In the first embodiment, a lookup table could be (pre) configured which links the CBR range and/or per packet priority value and/or caste type and/or CR limit with that of limiting/restricting each of the IUC schemes, shown in FIG. 4, such as:
scheme 1a-preferred resource set;
scheme 1b-non-preferred resource set;
scheme 2-expected/potential collision detection on the reserved resource, and/or corresponding methods such as
IUC information transmission triggered by a condition and/or
Using explicit request 406 transmitted by UE-B 404

Although the word ‘restricted’ or ‘limit’ is used throughout the specification, it also means that the corresponding preparation and/or transmission of a message 408 that includes a report for a particular scheme(s) may be dropped by UE-A 402 or the transmission of explicit request 406 from UE-B 404 is restricted or limited based on CBR and/or per packet priority. Above restriction of schemes and methods also helps in the selection of appropriate schemes and methods based on above limiting factors.

In one embodiment, restriction of the above IUC schemes and/or the corresponding methods could be (pre) configured for each CBR value/CBR range and per priority value or range of priority values where the priority is indicated as part of the priority field carried by first SCI payload. The scheme could be restricted based on CBR measurement when the SL RSSI measured by the UE in that resource exceeds a (pre-)configured threshold.

Restricting the usage of schemes reduces the signaling overhead during the congested scenario and while providing sufficient resources for the PSSCH transmission. For example, in the congested scenario, the scheme 1b provides a non-preferred resource set that may be beneficial compared to scheme 1a, which provides a preferred resource set. As the congestion level increases, the restriction may be placed on the transmission of IUC information in response to a condition-based trigger 410 for scheme 1a and scheme 1b based on the packet priority. When the congestion level reaches the maximum, scheme 2 provides information on the expected/potential resource conflict, which may be beneficial and/or detected resource conflict may be beneficial compared to scheme 1a or scheme 1b.

In one implementation, based on the CBR and/or the per packet priority, the transmission of explicit requests 406 from UE-B 404 to UE-A 402, or to one or more destination id(s) or cast type(s) may be restricted.

In another implementation, for the condition-based feedback, the restriction may be configured based on the cast type, one or more destinations, or the like, depending on the CBR and/or the per packet priority.

In another implementation, although the explicit request 406 may be received by UE-A 402 from UE-B 404 requesting the transmission of the IUC report, the transmission of one or more reports may be based on UE-A's estimated CBR value and/or the restriction/limitation due to UE-A CBR and/or per packet priority.

In another implementation, transmission of a message 408 comprising IUC information that is initiated by a condition-based trigger 410 from UE-A could be restricted based on its CBR and/or per packet priority and/or cast type, or the like.

In another implementation, a second threshold based on sidelink RSSI measurement could be (pre) configured per resource pool or sidelink BWP; otherwise, it is part of the congestion control parameter where the second threshold, which could be separately configured differently from the CBR threshold for the purpose of the restriction of the IUC scheme, when the Sidelink RSSI measured by the UE in that resource/resource pool/BWP exceeds a (pre-)configured second threshold.

In another implementation, the restriction on the IUC schemes may be (pre) configured as part of the sl-CBR-PSSCH-TxConfigList such that when CBR and per packet priority limits/restricts the transmission of PSSCH/PSCCH, then the corresponding limitation/restriction may also apply for one or more IUC schemes based on an explicit request and/or condition-based triggering.

An exemplary example of this embodiment may be shown using Table 3, where the IUC scheme is limited/restricted per CBR value/range and packet priority and in this example, the smaller priority value implies high priority QoS.

TABLE 3
Restriction of the scheme and method based on CBR and
per packet priority

| CBR | Priority 1-2 | Priority 3-5 | Priority 6-8 |
|---|---|---|---|
| 0 < CBR < 0.3 | No limit | No limit | No limit |
| 0.3 < CBR < 0.65 | No limit | No limit | Apply |
| | | | restriction to |
| | | | scheme 1a |
| | | | Condition based |
| 0.65 < CBR < 0.8 | No limit | Apply | Apply |
| | | restriction to | restriction to |
| | | scheme 1a | scheme 1a |
| | | Condition | Condition based |
| | | based | Trigger based |
| 0.8 < CBR < 1 | Apply | Apply | Apply |
| | restriction to | restriction to | restriction to |
| | scheme 1a | scheme 1a & 1b | scheme 1a & 1b |
| | Condition | Condition | Condition |
| | based | based | based |
| | Trigger based | Trigger based | Trigger based |

In another example, restriction of the inter-UE above coordination schemes could be configured for each CBR value/CBR range and per priority value or range of priority values where the priority is indicated as part of the priority field carried by first SCI payload as shown in Table 4.

TABLE 4
Restriction of the scheme based on the CBR and per
packet priority

| CBR | Priority 1-2 | Priority 3-5 | Priority 6-8 |
|---|---|---|---|
| 0 < CBR < 0.3 | No limit | No limit | No limit |
| 0.3 < CBR < 0.65 | No limit | No limit | Apply |
| | | | restriction to |
| | | | scheme 1a |
| 0.65 < CBR < 0.8 | No limit | Apply | Apply |
| | | restriction to | restriction to |
| | | scheme 1a | scheme 1a |
| 0.8 < CBR < 1 | Apply | Apply | Apply |
| | restriction to | restriction | restriction |
| | scheme 1a | to scheme | to scheme |
| | | 1a & 1b | 1a & 1b |

In some embodiments, the number of resources reported as part of the IUC message could be a limiting factor, considering that reporting more number/percentage of resources incurs more signaling overhead. For each CBR value/range and/or packet priority, restrict the number/percentage of reported resources corresponding to scheme 1a and/or scheme 1b, which could be (pre) configured per resource pool.

In another option, the number of resources reported could also be a function of CBR range and/or CR limit, where CR (channel occupancy) provides information on resource usage of a UE.

The resources are sorted according to the RSRP/RSSI values while reporting the set of resources as part of the IUC scheme. The number of resources may be restricted based on the cast type

An exemplary example of this implementation may be shown using the below table, where the number of resources reported as part of the IUC scheme 1a and 1b could be limited per CBR value/range and/or packet priority. In this example, the smaller priority value implies high priority.

TABLE 5
Restriction on the number of resources reported

| | Percentage of reported resources as part |
|---|---|
| CBR | of IUC scheme |
| 0 < CBR < 0.3 | 20 |
| 0.3 < CBR < 0.65 | 10 |
| 0.65 < CBR < 0.8 | 5 |
| 0.8 < CBR < 1 | 0 |

In some embodiments, if there are dedicated resources in one or more resource pool(s) or a separate resource pool (pre) configured for the transmission of one or more IUC reports:
The number of dedicated resources or percentage of resources within the resource pool allocated for the transmission of the IUC report may be a proportionally linked to the CBR range and/or priority/range of priority of that resource pool.
The restriction of one or more IUC scheme based on CBR and/or per packet priority could be applicable also for the transmission within the dedicated resources

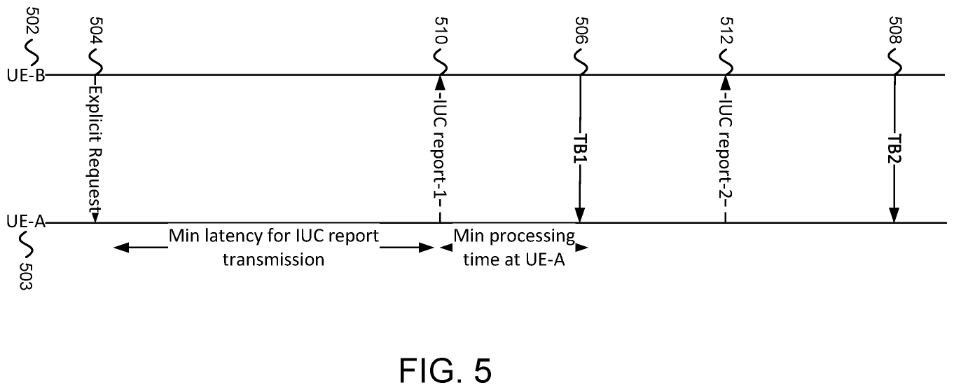

As shown in FIG. 5, for the case when UE-B 502 has periodic data transmission then the periodic transmission of an IUC report might be useful for the resource selection procedure at UE-B 502, then the explicit trigger 504 activates the transmission of periodic transmission of IUC report 510, 512, where the periodicity could be (pre) configured based on the traffic pattern, resource reservation interval. In this case, the start and end time window can be set according to a TB transmission 506, 508 within each period. Deactivation may be based on the explicit trigger. In another implementation, the activation/deactivation uses a new field in MAC CE.

In a second embodiment, directed to the UE-A 503 behavior when it receives the explicit request 504 for IUC when the CBR restricts the transmission of one or more IUC schemes, when an explicit IUC request comes from UE-B 502 to UE-A 503 and then the CBR limits or restricts the transmission of one or more schemes, then UE-A 503 could have the following behavior:
UE-A 503 may drop/ignore/skip the explicit request due to the limitation or restriction of one or more schemes due to higher CBR e.g., congested scenario, or based on a measured RSSI exceeding a (pre) configured threshold at UE-A 503, where a separate threshold may be (pre) configured compared to the CBR and in such cases IUC pending flag in MAC is not set accordingly;
UE-A 503 may report back to UE-B 502 why the transmission of a set of resources may be dropped, a field in MAC CE or SCI could be defined with a set of values and each set provides a specific reason for dropping or ignoring the IUC report 510, 512. As an example,
   01—IUC dropped due to prioritization;
   10—IUC dropped due to lack of resources;
   11—IUC dropped due to CBR or exceeding a (pre) configured threshold.
In the second implementation, UE-A 503 may override or ignore the limitation or restriction of one or more schemes due to higher CBR e.g., congested scenario. The explicit request 504 due to the high CBR e.g., from UE-A 503 when CBR restricts the transmission of the one or more schemes as indicated in the request message. If the explicit request contains a request for the transmission of a plurality of IUC reports 510, 512 and if one or more schemes are restricted based on the CBR and per packet priority limit, then the Tx UE may transmit a subset of the report which may comply with the CBR and per packet priority limit.
In the third implementation, when UE-B 502 does not receive the corresponding IUC report 510, 512 for which the request was transmitted, then UE-B 502 does not transmit a TB towards UE-A 503.

In some embodiments, when UE-B 502 does not receive the corresponding IUC report 510, 512 for which the request was transmitted, UE-B 502 waits until a (pre)-defined time until the PDB and selects resources based on its sensing result for the transmission of TB towards UE-A 503. If the IUC report 510, 512 arrives after the transmission of TB, UE-B 502 may (re) select if UE-B 502 does make some reservation or (pre) selected any resources for future new TB transmission or (re) transmission of the previous TB. The (pre)-defined time could be defined per priority and/or PDB value and could be configured per resource pool. The (pre)-defined wait time could be configured as minimum latency and maximum latency defined per priority and/or PDB for transmitting the IUC report 510, 512 for UE-A 503. The minimum latency of transmission of IUC report 510, 512 may consider the processing time or preparation time at UE-A 503 to do the sensing for preparing the IUC report 510, 512 and then latency for transmitting the report using mode 1 or mode 2 resource allocation procedure.

UE-B 502, while setting the start and end time of the resource selection window along with the explicit request, may set the end time corresponding to the buffer status, for e.g., when UE-B 502 has more data for transmitting towards UE-A 503 then instead of triggering the explicit request as many times may also set the end time of the resource selection window according to number of TBs that is going to transmit towards UE-A 503. In one example, the number of TBs that is going to transmit towards UE-A 503 could be easily calculated based on the number of Subchannel per TB transmission and amount of data in the L2 buffer. The start time could implicitly mean the latency at which the new TB transmission could be expected to be performed by UE-B 502; otherwise, the minimum latency for the transmission of the IUC report 510, 512.

When UE-B 502 does not receive the corresponding IUC report 510, 512 for which the request was transmitted, then the UE-B 502 may fall back to the scheme 2 relying on conflict indication on the reserved resources and/or post collision feedback based on the detected resource conflict on the transmitted TB.

For condition-based feedback, the start and the end time may be (pre) configured to the UE or per resource pool or based on the priority and/or PDB. In one embodiment, the latency for transmitting the IUC report 510, 512 using mode 1 or mode 2 resource allocation should be defined similar to the sidelink CSI reporting. For IUC report transmission, minimum and maximum latency should be (pre) configured per priority value and signaled to the UE or (pre) configured per resource pool.

In another implementation, the start time of the resource selection window might implicitly mean the latency at which the new TB transmission can be expected to be performed by UE-B 502; otherwise, the minimum latency for the transmission of the IUC report 510, 512 and the end time corresponds to that of maximum latency.

In a third embodiment, directed to MAC CE format for transmitting IUC report, when an IUC trigger contains transmission of one or more reports based on scheme 1a and/or scheme 1b, then a new MAC CE which is variable in size could be defined.

In one embodiment, the MAC CE field contains the source id/destination id, session id/trigger id, scheme type e.g., scheme 1a and/or scheme 1b, number of reported resources for scheme 1a, correspondingly the set of resources and then followed by scheme type again e.g., scheme 1a and/or scheme 1b, number of reported resources for scheme 1b, correspondingly set of resources, and/or the like.

In another implementation, two new MAC CEs with variable sizes could be defined one for the transmission of the scheme 1a and another MAC CE for transmitting the set of resource needed for scheme 1b each containing fields to indicate the type of report e.g., scheme 1a, scheme 1b, number of resources, source id/destination id, trigger id/session, and/or the like.

For condition based feedback, L_subCH is indicated in the MAC CE field. MAC CE priority could be (pre) configured. Otherwise, for the case of an explicit trigger, priority of the MAC CE is the same as that of the priority indicated in the explicit trigger. In one embodiment, one or more SR configurations could be associated with the transmission of the IUC report MAC CE, which may be used to indicate different MAC CE sizes to get mode 1 grant from gNB.

In another implementation, BSR contains a new field to indicate the variable MAC CE size. A truncated MAC CE could be transmitted when the number of reported resources is reduced and/or one of the schemes e.g., scheme 1a and/or scheme 1b may be dropped due to the congestion control mechanism or PSSCH resource is not sufficient and, in such cases, the pending trigger event is not cleared to enable the transmission of the remaining MAC CE.

In a fourth embodiment directed to IUC report transmission using SCI, a new second SCI format is defined for the transmission of one or more IUC report corresponding to scheme 1a and/or scheme 1b. The second SCI format contains one or more existing field supported by SCI format 2A and/or SCI format 2B to aid the decoding of the corresponding PSSCH such as RV, HARQ process no, and/or the like, and then a new field such as frequency domain assignment (“FDRA”) and time domain assignment (“TDRA”) for each of the scheme 1a and scheme 1b may be defined. If the report is not transmitted for one of the schemes, then the FDRA and TDRA fields could be set to invalid/reserved values. The number of bits allocated for FDRA and TDRA for each scheme could be (pre) configured per resource pool. The minimum granularity for the FDRA could be indicated according to L_subCH, which may be indicated as part of the explicit request and (pre) configured as part of the resource pool configuration for the condition-based feedback.

The latency for the transmission of one or more IUC report corresponding to scheme 1a and/or scheme 1b in the control channel together with the PSSCH could be determined based on the priority and latency of the IUC report and PSSCH data. The priority of the IUC report could be determined based on the indicated priority value in the received explicit request field and for the condition-based feedback it could be (pre) configured per resource pool. When the IUC report is transmitted along with the PSSCH in the same slot then the latency used for selecting resource could be considering the minimum latency among them or latency of the PSSCH.

The priority field in the SCI format IA could be set according to the highest priority of the IUC report and PSSCH (PSSCH priority is provided by higher layer), otherwise the priority field in SCI format IA is set according to the PSSCH priority provided by higher layer.

If there are multiple IUC reports for transmission from UE-A, then the selection of the IUC report for transmission is based on the intra-UE prioritization based on the corresponding priority value and/or latency requirement.

UE-B could trigger a second explicit trigger, only after the reception of the IUC report corresponding to the first explicit trigger. A second explicit trigger could be transmitted for different schemes different than the first explicit trigger and a second explicit trigger could be transmitted for a different resource pool compared to that of the first explicit trigger.

For condition-based feedback, SL an IUC prohibit timer is not applied when the IUC transmissions are autonomously triggered for different conditions and/or schemes. In another implementation, the SL IUC prohibit timer could be independently configured per condition and/or per scheme.

In a fifth embodiment, when UE-B triggers resource (re) selection and/or candidate resource selection after receiving the IUC report, the priority value, number of subchannel, L_subCH, resource reservation interval used in the candidate resource selection at UE-B should be same as that of the IUC report or same as that of the explicit trigger.

In the case where there is a mismatch between the priority and/or resource reservation interval and/or subchannel size (e.g., number of subchannel, L_subCH) indicated in the received IUC report at UE-B and that of the resource (re) selection at UE-B, then UE-B/PHY ignores the IUC report while performing sensing and candidate resource selection LCP restriction, if configured, is removed for selecting the destination.

If the L_subCH in the IUC report is larger compared to the L_subCH in the resource selection at UE-B, then the candidate resources are reported according to the L_subCH in the resource selection trigger and UE-B could use resource(s) belonging to the preferred resource set in combination with its own sensing result using the L_subCH parameter in the resource selection trigger.

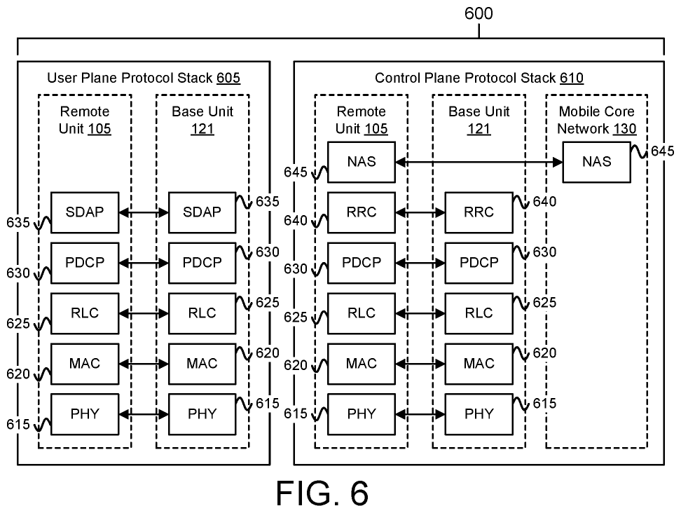

FIG. 6 depicts a NR protocol stack 600, according to embodiments of the disclosure. While FIG. 6 shows the remote unit 105, the base unit 121 and the mobile core network 130, these are representative of a set of UEs interacting with a RAN node and a NF (e.g., AMF) in a core network. As depicted, the NR protocol stack 600 comprises a User Plane protocol stack 605 and a Control Plane protocol stack 610. The User Plane protocol stack 605 includes a physical (“PHY”) layer 615, a Medium Access Control (“MAC”) sublayer 620, a Radio Link Control (“RLC”) sublayer 625, a Packet Data Convergence Protocol (“PDCP”) sublayer 630, and Service Data Adaptation Protocol (“SDAP”) layer 635. The Control Plane protocol stack 610 also includes a PHY layer 615, a MAC sublayer 620, a RLC sublayer 625, and a PDCP sublayer 630. The Control Plane protocol stack 610 also includes a Radio Resource Control (“RRC”) sublayer 640 and a Non-Access Stratum (“NAS”) sublayer 645.

The AS protocol stack for the Control Plane protocol stack 610 consists of at least RRC, PDCP, RLC and MAC sublayers, and the physical layer. The AS protocol stack for the User Plane protocol stack 605 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 640 and the NAS layer 645 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 615 offers transport channels to the MAC sublayer 620. The MAC sublayer 620 offers logical channels to the RLC sublayer 625. The RLC sublayer 625 offers RLC channels to the PDCP sublayer 630. The PDCP sublayer 630 offers radio bearers to the SDAP sublayer 635 and/or RRC layer 640. The SDAP sublayer 635 offers QoS flows to the mobile core network 130 (e.g., 5GC). The RRC layer 640 provides for the addition, modification, and release of Carrier Aggregation and/or Dual Connectivity. The RRC sublayer 640 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

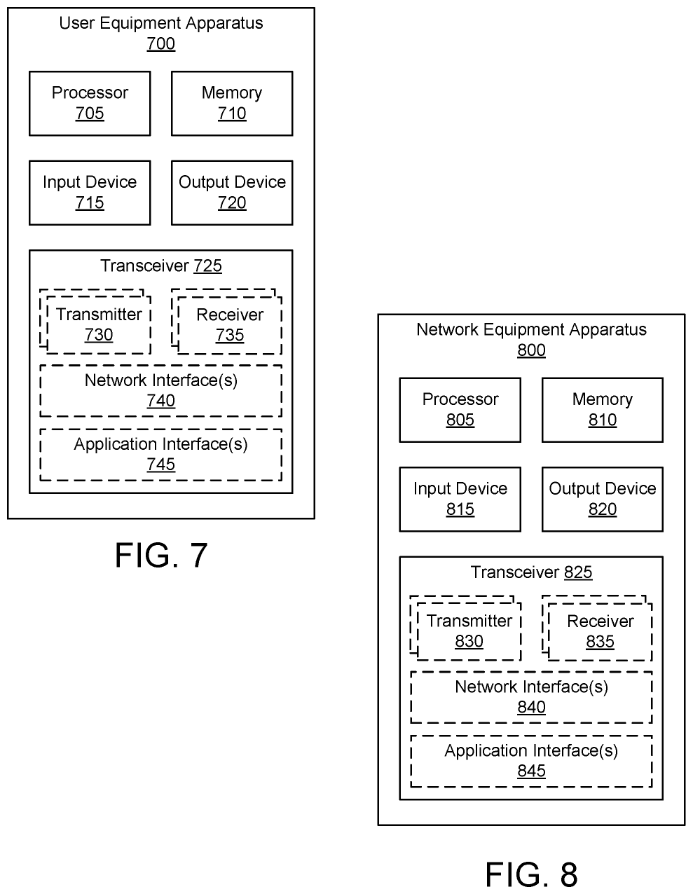

FIG. 7 depicts a UE apparatus 700 that may be used for restriction on the usage of IUC schemes during congestions, according to embodiments of the disclosure. In various embodiments, the UE apparatus 700 is used to implement one or more of the solutions described above. The UE apparatus 700 may be one embodiment of a UE, such as the remote unit 105 and/or the UE 205, as described above. Furthermore, the UE apparatus 700 may include a processor 705, a memory 710, an input device 715, an output device 720, and a transceiver 725. In some embodiments, the input device 715 and the output device 720 are combined into a single device, such as a touchscreen. In certain embodiments, the UE apparatus 700 may not include any input device 715 and/or output device 720. In various embodiments, the UE apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more base units 121. Additionally, the transceiver 725 may support at least one network interface 740 and/or application interface 745. The application interface(s) 745 may support one or more APIs. The network interface(s) 740 may support 3GPP reference points, such as Uu and PC5. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725. In certain embodiments, the processor 705 may include an application processor (also known as “main processor”) which manages application-domain and operating system (“OS”) functions and a baseband processor (also known as “baseband radio processor”) which manages radio functions.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to CSI enhancements for higher frequencies. For example, the memory 710 may store parameters, configurations, resource assignments, policies, and the like as described above. In certain embodiments, the memory 710 also stores program code and related data, such as an operating system or other controller algorithms operating on the UE apparatus 700, and one or more software applications.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the UE apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all, or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. The transceiver 725 may be used to provide UL communication signals to a base unit 121 and to receive DL communication signals from the base unit 121, as described herein. Similarly, the transceiver 725 may be used to transmit and receive SL signals (e.g., V2X communication), as described herein. Although only one transmitter 730 and one receiver 735 are illustrated, the UE apparatus 700 may have any suitable number of transmitters 730 and receivers 735. Further, the transmitter(s) 730 and the receiver(s) 735 may be any suitable type of transmitters and receivers. In one embodiment, the transceiver 725 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

In various embodiments, one or more transmitters 730 and/or one or more receivers 735 may be implemented and/or integrated into a single hardware component, such as a multi-transceiver chip, a system-on-a-chip, an ASIC, or other type of hardware component. In certain embodiments, one or more transmitters 730 and/or one or more receivers 735 may be implemented and/or integrated into a multi-chip module. In some embodiments, other components such as the network interface 740 or other hardware components/circuits may be integrated with any number of transmitters 730 and/or receivers 735 into a single chip. In such embodiment, the transmitters 730 and receivers 735 may be logically configured as a transceiver 725 that uses one more common control signals or as modular transmitters 730 and receivers 735 implemented in the same hardware chip or in a multi-chip module.

In one embodiment, the processor 705 is configured to identify a configuration comprising a lookup table defining a restriction of one or more IUC schemes between the UE apparatus 700 and a second apparatus and transmit an IUC report to the second apparatus according to the identified configuration and based at least in part on a request for the IUC report from the second apparatus or a condition.

In one embodiment, the restriction of the one or more IUC schemes is based on a CBR, a per-packet priority, a cast type, a destination, or a combination thereof.

In one embodiment, the restriction of the one or more IUC schemes is preconfigured for each CBR value or a range of values and per-priority value or a range of priority values, and wherein the priority is indicated as part of a priority field in a first SCI payload.

In one embodiment, the processor 705 is further configured to cause the apparatus to determine to transmit the IUC report based on a measured SL RSSI.

In one embodiment, the restriction of the one or more inter-UE schemes is based on a CBR measurement in response to the SL RSSI satisfying a threshold.

In one embodiment, the processor 705 is configured to cause the apparatus to transmit the IUC report using a MAC CE, SCI, or a combination thereof.

In one embodiment, the IUC report comprises resource information indicating one or more preferred resources, one or more non-preferred resources, or a combination thereof, and wherein an amount of the preferred or non-preferred resources is indicated in the IUC report based on a CBR, a per packet priority, a cast type, or a combination thereof.

In one embodiment, the processor 705 is configured to cause the apparatus to determine the amount of resources reported as a function of a CBR range, a COR threshold, or a combination thereof.

In one embodiment, the amount of preferred or non-preferred resources that are included in the IUC report comprises a number of resources, a percentage of resources, or a combination thereof.

In one embodiment, the processor 705 is configured to cause the apparatus to drop the request from the second apparatus for the IUC report due to a CBR.

In one embodiment, the processor 705 is configured to cause the apparatus to report a cause, for the dropped request from the second apparatus for the IUC report, in a MAC CE, SCI, or a combination thereof.

In one embodiment, candidate resource selection for transmission of transport blocks is delayed a predefined period of time in response to dropping the IUC report transmission to the second apparatus, the predefined period of time defined based on a per-packet priority, a packet delay budget value, or a combination thereof.

In one embodiment, the condition is selected from the group comprising at least one of detecting overlapping resources, detecting a reference signal reserve power satisfying a threshold, and detecting a half duplex operation during SL reception.

FIG. 8 depicts one embodiment of a network apparatus 800 that may be used for restriction on the usage of IUC schemes during congestions, according to embodiments of the disclosure. In some embodiments, the network apparatus 800 may be one embodiment of a RAN node and its supporting hardware, such as the base unit 121 and/or gNB, described above. Furthermore, network apparatus 800 may include a processor 805, a memory 810, an input device 815, an output device 820, and a transceiver 825. In certain embodiments, the network apparatus 800 does not include any input device 815 and/or output device 820.

As depicted, the transceiver 825 includes at least one transmitter 830 and at least one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2, N3, N5, N6 and/or N7 interfaces. Other network interfaces 840 may be supported, as understood by one of ordinary skill in the art.

When implementing an NEF, the network interface(s) 840 may include an interface for communicating with an application function (i.e., N5) and with at least one network function (e.g., UDR, SFC function, UPF) in a mobile communication network, such as the mobile core network 130.

The processor 805, in one embodiment, may include any known controller capable of executing computer-readable instructions and/or capable of performing logical operations. For example, the processor 805 may be a microcontroller, a microprocessor, a CPU, a GPU, an auxiliary processing unit, an FPGA, a DSP, a co-processor, an application-specific processor, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825. In certain embodiments, the processor 805 may include an application processor (also known as “main processor”) which manages application-domain and OS functions and a baseband processor (also known as “baseband radio processor”) which manages radio function. In various embodiments, the processor 805 controls the network apparatus 800 to implement the above described network entity behaviors (e.g., of the gNB) for restriction on the usage of IUC schemes during congestions.

The memory 810, in one embodiment, is a computer readable storage medium. In some embodiments, the memory 810 includes volatile computer storage media. For example, the memory 810 may include a RAM, including DRAM, SDRAM, and/or SRAM. In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data relating to CSI enhancements for higher frequencies. For example, the memory 810 may store parameters, configurations, resource assignments, policies, and the like as described above. In certain embodiments, the memory 810 also stores program code and related data, such as an operating system (“OS”) or other controller algorithms operating on the network apparatus 800, and one or more software applications.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, may include any known electronically controllable display or display device. The output device 820 may be designed to output visual, audible, and/or haptic signals. In some embodiments, the output device 820 includes an electronic display capable of outputting visual data to a user. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all, or portions of the output device 820 may be integrated with the input device 815. For example, the input device 815 and output device 820 may form a touchscreen or similar touch-sensitive display. In other embodiments, all, or portions of the output device 820 may be located near the input device 815.

As discussed above, the transceiver 825 may communicate with one or more remote units and/or with one or more interworking functions that provide access to one or more PLMNs. The transceiver 825 may also communicate with one or more network functions (e.g., in the mobile core network 80). The transceiver 825 operates under the control of the processor 805 to transmit messages, data, and other signals and also to receive messages, data, and other signals. For example, the processor 805 may selectively activate the transceiver (or portions thereof) at particular times in order to send and receive messages.

The transceiver 825 may include one or more transmitters 830 and one or more receivers 835. In certain embodiments, the one or more transmitters 830 and/or the one or more receivers 835 may share transceiver hardware and/or circuitry. For example, the one or more transmitters 830 and/or the one or more receivers 835 may share antenna(s), antenna tuner(s), amplifier(s), filter(s), oscillator(s), mixer(s), modulator/demodulator(s), power supply, and the like. In one embodiment, the transceiver 825 implements multiple logical transceivers using different communication protocols or protocol stacks, while using common physical hardware.

In one embodiment, the processor 805 is configured to transmit a request to a second apparatus for an IUC report associated with one or more IUC schemes between the apparatus and the second apparatus. In one embodiment, in response to the transmitted request, the processor 805 is configured to wait a predefined period of time until a packet delay budget, select, in response to waiting the predefined period of time, one or more resources based on a sensing result for transmission of a transport block towards the second apparatus, and receive, using the selected resources, a report from the second apparatus comprising a reason that the IUC report was not transmitted.

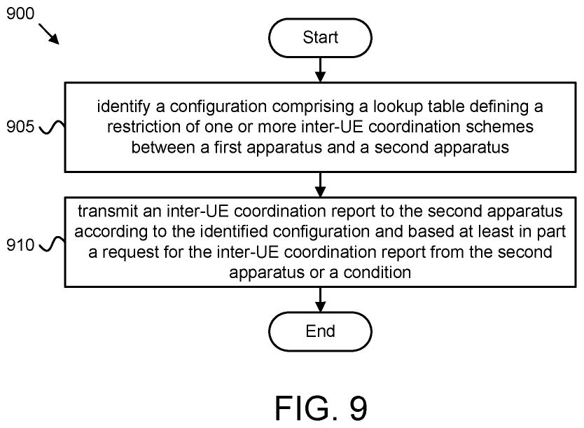

FIG. 9 is a flowchart diagram of a method 900 for restriction on the usage of IUC schemes during congestion. The method 900 may be performed by a UE as described herein, for example, the remote unit 105 and/or the UE apparatus 700. In some embodiments, the method 900 may be performed by a processor executing program code, for example, a microcontroller, a microprocessor, a CPU, a GPU, an auxiliary processing unit, a FPGA, or the like.

In one embodiment, the method 900 begins and identifies 905 a configuration comprising a lookup table defining a restriction of one or more IUC schemes between a first apparatus and a second apparatus and transmits 910 an IUC report to the second apparatus according to the identified configuration and based at least in part on a request for the IUC report from the second apparatus or a condition, and the method 900 ends.

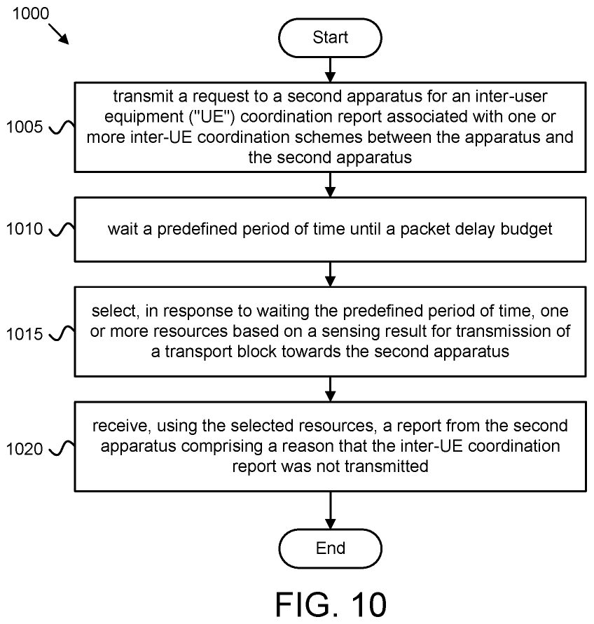

FIG. 10 is a flowchart diagram of a method 1000 for restriction on the usage of IUC schemes during congestion. The method 1000 may be performed by a UE as described herein, for example, the remote unit 105 and/or the UE apparatus 700. In some embodiments, the method 1000 may be performed by a processor executing program code, for example, a microcontroller, a microprocessor, a CPU, a GPU, an auxiliary processing unit, a FPGA, or the like.

In one embodiment, the method 1000 begins and transmits 1005 a request to a second apparatus for an IUC report associated with one or more IUC schemes between the apparatus and the second apparatus. In one embodiment, in response to the transmitted request, the method 1000 waits 1010 a predefined period of time until a packet delay budget, selects 1015, in response to waiting the predefined period of time, one or more resources based on a sensing result for transmission of a transport block towards the second apparatus, and receives 1020, using the selected resources, a report from the second apparatus comprising a reason that the IUC report was not transmitted, and the method 1000 ends.

A first apparatus is disclosed for restriction on the usage of IUC schemes during congestion. The first apparatus may include a UE as described herein, for example, the remote unit 105 and/or the UE apparatus 700. In some embodiments, the first apparatus includes a processor executing program code, for example, a microcontroller, a microprocessor, a CPU, a GPU, an auxiliary processing unit, an FPGA, or the like.

In one embodiment, the first apparatus includes a memory and a processor coupled to the memory. In one embodiment, the processor is configured to cause the apparatus to identify a configuration comprising a lookup table defining a restriction of one or more IUC schemes between the apparatus and a second apparatus and transmit an IUC report to the second apparatus according to the identified configuration and based at least in part on a request for the IUC report from the second apparatus or a condition.

In one embodiment, the restriction of the one or more IUC schemes is based on a CBR, a per-packet priority, a cast type, a destination, or a combination thereof.

In one embodiment, the restriction of the one or more IUC schemes is preconfigured for each CBR value or a range of values and per-priority value or a range of priority values, and wherein the per-priority value or the range of priority values is indicated by one or more priority fields in a first SCI payload.

In one embodiment, the processor is further configured to cause the apparatus to determine to transmit the IUC report based on a measured SL RSSI.

In one embodiment, the restriction of the one or more inter-UE schemes is based on a CBR measurement in response to the SL RSSI satisfying a threshold.

In one embodiment, the processor is configured to cause the apparatus to transmit the IUC report using a MAC CE, SCI, or a combination thereof.

In one embodiment, the IUC report comprises resource information indicating one or more preferred resources, one or more non-preferred resources, or a combination thereof, and wherein an amount of the preferred or non-preferred resources is indicated in the IUC report based on a CBR, a per packet priority, a cast type, or a combination thereof.

In one embodiment, the processor is configured to cause the apparatus to determine the amount of resources reported as a function of a CBR range, a COR threshold, or a combination thereof.

In one embodiment, the amount of preferred or non-preferred resources that are included in the IUC report comprises a number of resources, a percentage of resources, or a combination thereof.

In one embodiment, the processor is configured to cause the apparatus to drop the request from the second apparatus for the IUC report due to a CBR.

In one embodiment, the processor is configured to cause the apparatus to report a cause, for the dropped request from the second apparatus for the IUC report, in a MAC CE, SCI, or a combination thereof.

In one embodiment, candidate resource selection for transmission of transport blocks is delayed a predefined period of time in response to dropping the IUC report transmission to the second apparatus, the predefined period of time defined based on a per-packet priority, a packet delay budget value, or a combination thereof.

In one embodiment, the condition is selected from the group comprising at least one of detecting overlapping resources, detecting a reference signal reserve power satisfying a threshold, and detecting a half duplex operation during SL reception.

A first method is disclosed for restriction on the usage of IUC schemes during congestion. The first method may be performed by a UE as described herein, for example, the remote unit 105 and/or the UE apparatus 700. In some embodiments, the first method may be performed by a processor executing program code, for example, a microcontroller, a microprocessor, a CPU, a GPU, an auxiliary processing unit, an FPGA, or the like.

In one embodiment, the first method identifies a configuration comprising a lookup table defining a restriction of one or more IUC schemes between a first apparatus and a second apparatus and transmits an IUC report to the second apparatus according to the identifies configuration and based at least in part on a request for the IUC report from the second apparatus or a condition.

In one embodiment, the restriction of the one or more IUC schemes is based on a CBR, a per-packet priority, a cast type, a destination, or a combination thereof.

In one embodiment, the restriction of the one or more IUC schemes is preconfigured for each CBR value or a range of values and per-priority value or a range of priority values, and wherein the per-priority value or the range of priority values is indicated by one or more priority fields in a first SCI payload.

In one embodiment, the first method determines to transmit the IUC report based on a measured SL RSSI.

In one embodiment, the restriction of the one or more inter-UE schemes is based on a CBR measurement in response to the SL RSSI satisfying a threshold.

In one embodiment, the first method transmits the IUC report using a MAC CE, SCI, or a combination thereof.

In one embodiment, the IUC report comprises resource information indicating one or more preferred resources, one or more non-preferred resources, or a combination thereof, and wherein an amount of the preferred or non-preferred resources is indicated in the IUC report based on a CBR, a per packet priority, a cast type, or a combination thereof.

In one embodiment, the first method determines the amount of resources reported as a function of a CBR range, a COR threshold, or a combination thereof.

In one embodiment, the amount of preferred or non-preferred resources that are included in the IUC report comprises a number of resources, a percentage of resources, or a combination thereof.

In one embodiment, the first method drops the request from the second apparatus for the IUC report due to a CBR.

In one embodiment, the first method reports a cause, for the dropped request from the second apparatus for the IUC report, in a MAC CE, SCI, or a combination thereof.

In one embodiment, candidate resource selection for transmission of transport blocks is delayed a predefined period of time in response to dropping the IUC report transmission to the second apparatus, the predefined period of time defined based on a per-packet priority, a packet delay budget value, or a combination thereof.

In one embodiment, the condition is selected from the group comprising at least one of detecting overlapping resources, detecting a reference signal reserve power satisfying a threshold, and detecting a half duplex operation during SL reception.

A second apparatus is disclosed for restriction on the usage of IUC schemes during congestion. The second apparatus may include a UE as described herein, for example, the remote unit 105 and/or the UE apparatus 700. In some embodiments, the second apparatus includes a processor executing program code, for example, a microcontroller, a microprocessor, a CPU, a GPU, an auxiliary processing unit, an FPGA, or the like.

In one embodiment, the second apparatus includes a memory and a processor coupled to the memory. In one embodiment, the processor is configured to cause the apparatus to transmit a request to a second apparatus for an IUC report associated with one or more IUC schemes between the apparatus and the second apparatus. In one embodiment, in response to the transmitted request, the processor is configured to cause the apparatus to wait a predefined period of time until a packet delay budget, select, in response to waiting the predefined period of time, one or more resources based on a sensing result for transmission of a transport block towards the second apparatus, and receive, using the selected resources, a report from the second apparatus comprising a reason that the IUC report was not transmitted.

A second method is disclosed for restriction on the usage of IUC schemes during congestion. The second method may be performed by a UE as described herein, for example, the remote unit 105 and/or the UE apparatus 700. In some embodiments, the second method may be performed by a processor executing program code, for example, a microcontroller, a microprocessor, a CPU, a GPU, an auxiliary processing unit, an FPGA, or the like.

In one embodiment, the second method transmits a request to a second apparatus for an IUC report associated with one or more IUC schemes between the apparatus and the second apparatus. In one embodiment, in response to the transmitted request, the second method waits a predefined period of time until a packet delay budget, selects, in response to waiting the predefined period of time, one or more resources based on a sensing result for transmission of a transport block towards the second apparatus, and receives, using the selected resources, a report from the second apparatus comprising a reason that the IUC report was not transmitted.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a memory; and
a processor coupled to the memory, the processor configured to cause the apparatus to:
identify a configuration comprising a lookup table defining a restriction of one or more inter-user equipment (“UE”) coordination schemes between the apparatus and a second apparatus; and
transmit an inter-UE coordination report to the second apparatus according to the identified configuration and based at least in part on a request for the inter-UE coordination report from the second apparatus or a condition.

2. The apparatus of claim 1, wherein the restriction of the one or more inter-UE coordination schemes is based on a channel busy ratio (“CBR”), a per-packet priority, a cast type, a destination, or a combination thereof.

3. The apparatus of claim 1, wherein the restriction of the one or more inter-UE coordination schemes is preconfigured for each channel busy ratio (“CBR”) value or a range of values and per-priority value or a range of priority values, and wherein the per-priority value or the range of priority values is indicated by one or more priority fields in a first sidelink control information (“SCI”) payload.

4. The apparatus of claim 1, wherein the processor is further configured to cause the apparatus to determine to transmit the inter-UE coordination report based on a measured sidelink (“SL”) received signal strength indicator (“RSSI”).

5. The apparatus of claim 4, wherein the restriction of the one or more inter-UE schemes is based on a channel busy ratio (“CBR”) measurement in response to the SL RSSI satisfying a threshold.

6. The apparatus of claim 1, wherein the processor is configured to cause the apparatus to transmit the inter-UE coordination report using a medium access control (“MAC”) control element (“CE”), sidelink control information (“SCI”), or a combination thereof.

7. The apparatus of claim 1, wherein the inter-UE coordination report comprises resource information indicating one or more preferred resources, one or more non-preferred resources, or a combination thereof, and wherein an amount of the preferred or non-preferred resources is indicated in the inter-UE coordination report based on a channel busy ratio (“CBR”), a per packet priority, a cast type, or a combination thereof.

8. The apparatus of claim 7, wherein the processor is configured to cause the apparatus to determine the amount of resources reported as a function of a CBR range, a channel occupancy ratio (“CR”) threshold, or a combination thereof.

9. The apparatus of claim 7, wherein the amount of preferred or non-preferred resources that are included in the inter-UE coordination report comprises a number of resources, a percentage of resources, or a combination thereof.

10. The apparatus of claim 1, wherein the processor is configured to cause the apparatus to drop the request from the second apparatus for the inter-UE coordination report due to a channel busy ratio (“CBR”).

11. The apparatus of claim 10, wherein the processor is configured to cause the apparatus to report a cause, for the dropped request from the second apparatus for the inter-UE coordination report, in a medium access control (“MAC”) control element (“CE”), sidelink control information (“SCI”), or a combination thereof.

12. The apparatus of claim 11, wherein candidate resource selection for transmission of transport blocks is delayed a predefined period of time in response to dropping the inter-UE coordination report to the second apparatus, the predefined period of time defined based on a per-packet priority, a packet delay budget value, or a combination thereof.

13. The apparatus of claim 1, wherein the condition is selected from the group comprising at least one of detecting overlapping resources, detecting a reference signal received power satisfying a threshold, and detecting a half duplex operation during sidelink (“SL”) reception.

14. A method, comprising:
identifying a configuration comprising a lookup table defining a restriction of one or more inter-user equipment (“UE”) coordination schemes between a first apparatus and a second apparatus; and
transmitting an inter-UE coordination report to the second apparatus according to the identified configuration and based at least in part on a request for the inter-UE coordination report from the second apparatus or a condition.

15. An apparatus, comprising:
a memory; and
a processor coupled to the memory, the processor configured to cause the apparatus to:
transmit a request to a second apparatus for an inter-user equipment (“UE”) coordination report associated with one or more inter-UE coordination schemes between the apparatus and the second apparatus;
in response to the transmitted request:
wait a predefined period of time until a packet delay budget;
select, in response to waiting the predefined period of time, one or more resources based on a sensing result for transmission of a transport block towards the second apparatus; and
receive, using the selected resources, a report from the second apparatus comprising a reason that the inter-UE coordination report was not transmitted.
